(19) United States
(12) Patent Application Publication
(10) Pub. No.: US 2026/0185838 A1
(43) Pub. Date: Jul. 2, 2026

(54) SYSTEMS AND METHODS FOR ROUTE GENERATION

(71) Applicant: Quanata, LLC, San Francisco, CA (US)

(72) Inventors: John Kramer, Mechanicsburg, PA (US); Michael Spenser Weiss, San Marcos, CA (US)

(73) Assignee: Quanata, LLC, San Francisco, CA (US)

(21) Appl. No.: 19/006,882

(22) Filed: Dec. 31, 2024

(51) Int. Cl. G01C 21/34

(52) U.S. Cl. CPC G01C 21/3461; G01C 21/3484; G01C 21/3492

(57) ABSTRACT

A method can include receiving first data regarding roads, a vehicle, and a user of the vehicle; receiving modeled data for the vehicle, wherein the modeled data is generated at least by applying at least one predictive model to the first data; receiving a destination; receiving a first location; generating potential routes for the user to operate the vehicle along the roads from the first location to the destination; generating risk assessments for the potential routes based on the first data; selecting an identified route of the potential routes; and transmitting the identified route to an electronic device of the user. Other embodiments are disclosed.

### FIELD OF THE DISCLOSURE

The present disclosure generally relates to generating and/or identifying travel routes based on risk assessments.

### BACKGROUND

Navigation systems generate travel routes to identify the fastest route. However, the fastest route is not necessarily the safest route. Therefore, systems and methods are desired to generate and/or identify travel routes based on risk assessments.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an embodiment of the system disclosed in FIG. 3;

FIG. 2 illustrates a representative block diagram of an example of the elements included on the circuit boards inside a chassis of the computer system of FIG. 1;

FIG. 3 illustrates a system for generating travel routes, according to an embodiment;

FIG. 4 illustrates a flow chart for a method of generating travel routes, according to an embodiment;

FIG. 5 illustrates a flow chart for a first embodiment of a portion of the method in FIG. 4;

FIG. 6 illustrates a flow chart for a second embodiment of the portion of the method in FIG. 4; and

FIG. 7 illustrates a flow chart for a method of generating travel routes, according to another embodiment.

The figures depict embodiments for purposes of illustration only. One skilled in the art will readily recognize from the following discussion that other embodiments of the systems and methods illustrated herein can be employed without departing from the principles of the technology described herein.

### DETAILED DESCRIPTION OF THE DRAWINGS

The present embodiments can generally relate to generating and/or identifying travel routes based on risk assessments, which can be useful for, inter alia, reducing risk to keep drivers and/or passengers in vehicles safer, reducing risk to keep vehicles safer, reducing risk to keep people on the roadside safer, reducing wear and tear on certain roads, reducing wear and tear on vehicles, recommending vehicle maintenance, coaching to reduce unsafe driving behaviors, recommending vehicles for purchase, recommending billboard locations and other roadside advertisement locations, providing insurance discounts, and lowering credit scores. Applications of the technology described herein can promote safety for people, regardless of whether the people are drivers of vehicles, passengers in vehicles, or people on the roadside. The applications also can promote safety for things (i.e., vehicles, equipment on the roadside, buildings on the roadside, roads themselves, etc.).

For example, reducing risk to keep drivers and/or passengers in vehicles safer (and to keep vehicles safer) can include recommending a least risky route or recommending a route balanced between risk and duration of travel, and does not necessarily recommend the fastest route (i.e., the shortest duration of travel). Current technology recommends fastest routes by taking into account real-time data such as traffic data, and by maximizing efficiency. In contrast, the technology described herein can be used to keep drivers and passengers in vehicles safer and to keep vehicles safer, while considering efficiency, but not necessarily making efficiency a primary factor.

Reducing risk to keep people on the roadside safer can include recommending vehicles to stay away from road construction zones and/or roadside construction zones (i.e., building construction next to a road), thus keeping construction workers, among other people, safer. Reducing wear and tear on roads can be used by a government's Department of Transportation to route vehicles away from roads that have potholes or that otherwise need repair, especially those roads that need repair but are not scheduled for repair due to delays, labor shortages, and/or budget issues. Reducing wear and tear on vehicles can include not recommending routes for vehicles that have unpaved surfaces (or are otherwise bumpy due to potholes, etc.) when a vehicle's suspension system needs to be serviced or replaced. In contrast, current technology does not consider these safety factors when recommending travel routes.

Recommending vehicle maintenance can include recommending to replace shock absorbers for a vehicle when the telematics data for the vehicle shows unusually bumpy rides for the vehicle, excessive bouncing of the vehicle, nose dives and squats for the vehicle upon breaking, poor handling of the vehicle, unusual wear on the vehicle, etc. Coaching to reduce unsafe driving behaviors can include recommending to reduce speeds and to start braking earlier before stop signs and red traffic lights.

Recommending vehicles for purchase can be used by an original equipment manufacturer (OEM) of vehicles to recommend a vehicle to an OEM customer based on the customer's preferences for route safety and based on the vehicle's safety rating. Recommending billboard locations and other roadside advertisement locations can be used by advertisers to identify roadside locations that are safer for drivers to view roadside advertisements. Providing insurance discounts cand be used by insurance companies based on driver preferences for safer routes. Lowering credit scores can be used by financial institutions also based on driver preferences for safer routes.

Traditional systems and methods rely on real-time data such as traffic data, but the systems (including hardware and software) and methods described herein can use real-time data, static data, historical data, static risk, and historic risk, which permits the systems and methods herein to assess risks for travel routes. As an example, static data can be physical characteristics of a road such as the pitch and yaw of a road, school zones, etc. As another example, historical data can be exposure data, such as accident rates at intersections, car maintenance data, historic telematics data for a driver (e.g., known speed, cornering speeds, stopping distances, etc.), driver behavior based on the historic telematics data (e.g., prefers highways to backroads because the driver exceeds the speed limit more often on residential roads), etc. As an additional example, static risk can be hard turns on roads, winding roads with hair pin turns, no stop signs or traffic signals at intersections, one way streets, one lane bridges, roads with blind spots, intersections, bottlenecks where the number of lanes on the road decrease, missing or unclear road signs, roads with poor water drainage, gravel or dirt roads, local roads not maintained by townships or state departments of transportation, steep mountain roads with runaway truck zones, railroad crossings, pedestrian cross walks, school zones, etc. As a further example, historic risk can be accident propensity related to vehicle type (based on time of day, traffic density, weather, etc.) versus active accident scenes, propensity for natural disaster (e.g., floods, snow, ice, earthquakes, tornadoes, etc.) versus active or potentially undocumented issues (e.g., computer software modeled issues), how a driver has behaved or has maneuvered on a type of road and the likelihood for accidents versus how the driver drives in real time, historic school zones accidents during student drop off and pick up days and times, historic cross walk accidents near schools, roads near high schools with higher volumes of young and inexperienced drivers, etc.

More specifically, various embodiments can include a method being implemented via execution of computing instructions configured to run on one or more processors and stored on one or more non-transitory computer-readable media. The method can include receiving first data regarding roads, a vehicle, and a user of the vehicle; receiving modeled data for the vehicle, wherein the modeled data is generated at least by applying at least one predictive model to the first data; receiving a destination; receiving a first location; generating potential routes for the user to operate the vehicle along the roads from the first location to the destination; generating risk assessments for the potential routes based on the first data; selecting an identified route of the potential routes; and transmitting the identified route to an electronic device of the user. The identified route can include at least one of fewer risks or lower risks compared to one or more other routes of the potential routes and based on the risk assessments for the potential routes.

In other embodiments, a system can be provided. The system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, artificial intelligence bots, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more operations.

The operations can include: receiving first data regarding roads, a vehicle, and a user of the vehicle; receiving modeled data for the vehicle, wherein the modeled data is generated at least by applying at least one predictive model to the first data; receiving a destination; receiving a first location; generating potential routes for the user to operate the vehicle along the roads from the first location to the destination; generating risk assessments for the potential routes based on the first data; selecting an identified route of the potential routes; and transmitting the identified route to an electronic device of the user. The identified route can include at least one of fewer risks or lower risks compared to one or more other routes of the potential routes and based on the risk assessments for the potential routes.

In further embodiments, a non-transitory computer readable storage medium storing computing instructions can be provided. The computing instructions, when run on one or more processors, can cause the one or more processors to perform operations. The operations can include: receiving first data regarding roads, a vehicle, and a user of the vehicle; receiving modeled data for the vehicle, wherein the modeled data is generated at least by applying at least one predictive model to the first data; receiving a destination; receiving a first location; generating potential routes for the user to operate the vehicle along the roads from the first location to the destination; generating risk assessments for the potential routes based on the first data; selecting an identified route of the potential routes; and transmitting the identified route to an electronic device of the user. The identified route can include at least one of fewer risks or lower risks compared to one or more other routes of the potential routes and based on the risk assessments for the potential routes.

Advantages will become more apparent to those skilled in the art from the description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

In some embodiments, the techniques described herein can provide one or more practical applications and technological improvements. For example, the techniques described herein can provide a technical improvement to identifying routes more suitable for worn tires that need to be replaced or thin brake pads that need to be replaced. As an example, the techniques described herein can be used to recommend higher elevation roads or roads that typically flood less if the vehicle is known or predicted to have worn tires that need to be replaced. The techniques described herein also can predict whether the tires of the vehicle are worn based on historical data for vehicle maintenance where the tire tread was measured and also based on historic telematics data showing how many miles were driven since the last vehicle maintenance, whether tire wear is above average because the driver takes sharp corners at high speed, brakes quickly or suddenly, and so on If a vehicle has worn tires, then the techniques herein might not be able to recommend a safe route, but rather a safer route compared to other routes to avoid standing water, and such factors (e.g., avoiding standing water) can be weighted more heavily when the tires on the vehicle are worn (or predicted to be worn) and need to be replaced due to the reduced ability of the vehicle to stop quickly and/or maintain traction on the road.

The techniques described herein also can provide improvement over conventional approaches that merely consider real-time data Accordingly, the techniques described herein can evaluate historic traffic data and historic accident rates along the route, in addition to real time traffic data along the route, to more accurately predict risks of traffic accidents on the route because, when traffic density is high, there is a higher likelihood of an accident occurring. Recommending a travel route that has less traffic might require the driver to drive a longer distance and/or drive a longer time, but the recommended travel route will be safer.

Additionally, the techniques described herein can further provide improvement over conventional approaches that do not consider real-time weather factors to reduce other risks for which no data is available. As such, these techniques can increase the confidence that users have in the recommended route. For example, when deer are in rut and on the move near particular roads, there can be higher vehicle collisions with the deer along those particular roads. Therefore, the systems and methods described herein can recommend a travel route that does not involve driving down those particular roads during the season when deer are in rut, especially if the real-time weather shows fog. This recommendation can be made even if the system and method do not have access to or otherwise cannot use real-time deer location data. The techniques described herein can provide improvement over conventional approaches that do not perform one or more of the functions described herein.

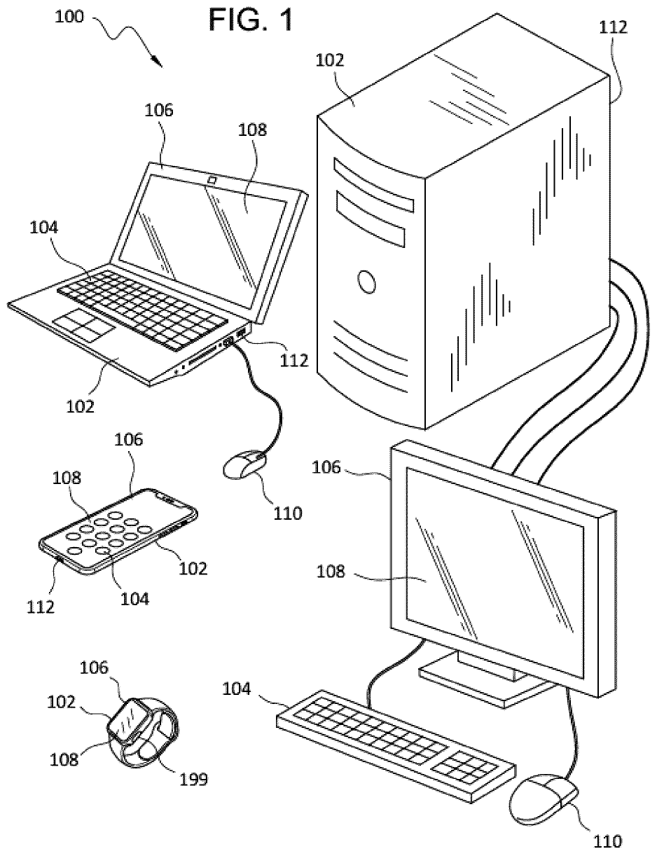

Turning to the drawings, FIG. 1 illustrates an embodiment of four different types (e.g., a laptop, a tower server, a smartphone, and a smartwatch) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

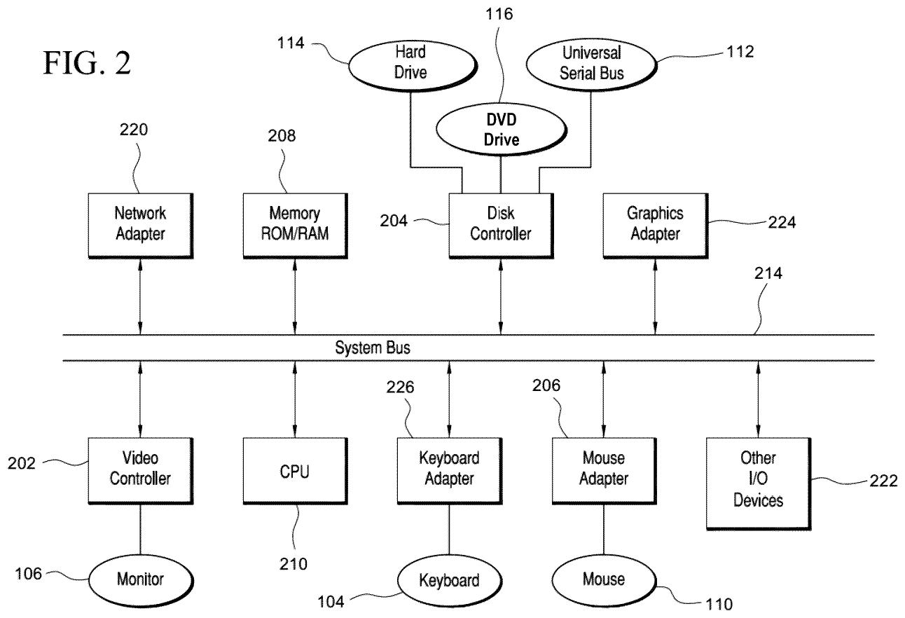

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O (input/output) devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

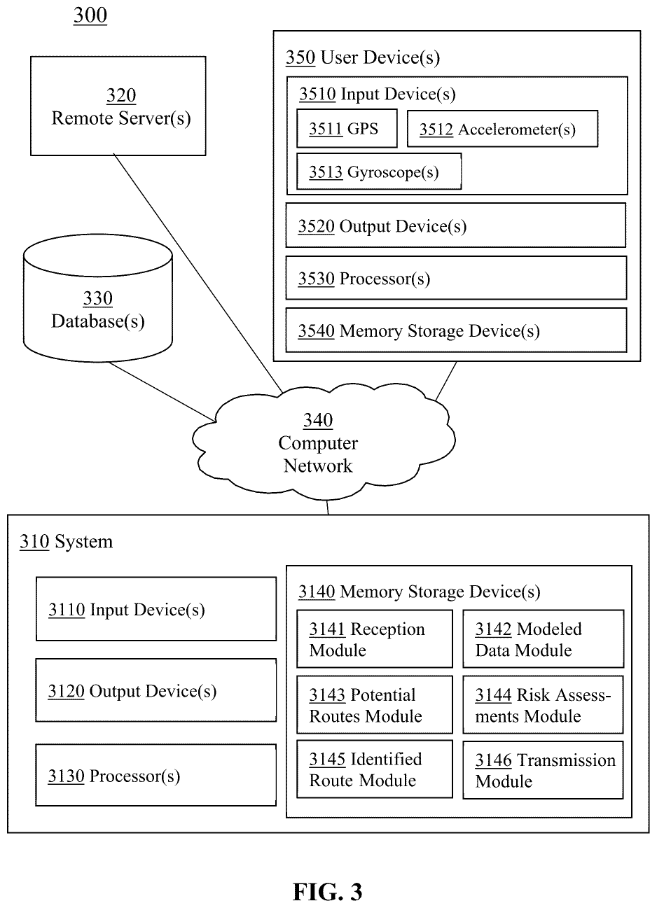

Turning ahead in the drawings, FIG. 3 illustrates a block diagram of a system 300 for generating travel routes, which can include reducing risk to keep drivers and/or passengers in vehicles safer, reducing risk to keep vehicles safer, reducing risk to keep people on the roadside safer, reducing wear and tear on certain roads, reducing wear and tear on vehicles, recommending vehicle maintenance, coaching to reduce unsafe driving behaviors, recommending vehicles for purchase, recommending billboard locations and other roadside advertisement locations, providing insurance discounts, and lowering credit scores, according to various embodiments. System 300 is not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more databases (e.g., a database(s) 330), one or more remote servers (e.g., a remote server(s) 320), and one or more first user devices (e.g., a first user device(s) 350), and a computer system (e.g., system 310). Database(s) 330, remote server(s) 320, first user device(s) 350, and system 310 can each be a computer system, such as computer system 100 (FIG. 1), as described above, and can each be a single computer, a single server, or a cluster or collection of computers or servers, or a cloud of computers or servers. In another embodiment, a single computer system can host each of database(s) 330, remote server(s) 320, first user device(s) 350, and system 310.

In some embodiments, each of first user device(s) 350 can include modules of computing instructions (e.g., software modules) stored on non-transitory computer readable media (e.g., memory storage device(s) 3540) that operate on one or more processors (e.g., processor(s) 3530). In other embodiments, first user device(s) 350 can be implemented in hardware, including ASICs (application specific integrated circuits) and the like. In some embodiments, system 310 can comprise one or more systems, subsystems, modules, models, or servers (e.g., a reception module 3141, a modeled data module 3142, a potential routes module 3143, a risk assessments module 3144, an identified route module 3145, a transmission module 3146, etc.). Each of reception module 3141, modeled data module 3142, potential routes module 3143, risk assessments module 3144, identified route module 3145, and transmission module 3146 can be implemented, at least in part, in software and/or firmware stored in or loaded on one or more memory storage device(s) (e.g., memory storage device(s) 3140) of system 310 and executed on processor(s) 3130 of system 310. In various embodiments, one or more of reception module 3141, modeled data module 3142, potential routes module 3143, risk assessments module 3144, identified route module 3145, and transmission module 3146 can include one or more of trained machine learning (ML) and/or artificial intelligence (AI) models (the ML/AI models).

In some embodiments, first user device(s) 350 can be in data communication, through a computer network, a telephone network, or the Internet (e.g., computer network 340), with remote server(s) 320, database(s) 330, and/or system 310. In other embodiments, first user device(s) 350 can be in direct communication with other components of system 300 using, for example, Bluetooth communication. In some embodiments, as explained below, first user device(s) 350 can be mobile device(s) (such as smartphone(s)) used by user(s), such as driver(s) or operator(s) of one or more vehicles.

In certain embodiments, first user device(s) 350, remote server(s) 320, and/or system 310 can host one or more websites and/or mobile application servers. For example, first user device(s) 350, remote server(s) 320, and/or system 310 can host a website, or provide a server that interfaces with an application (e.g., a mobile application or a web browser), on first user device(s) 350. In some embodiments, an internal network (e.g., computer network 340) that is not open to the public can be used for communications between first user device(s) 350, database(s) 330, remote server(s) 320, and/or system 310 within system 300.

In some embodiments, each of system 310 and first user device(s) 350 can include one or more input devices (e.g., input device(s) 3110 and 3510, respectively), one or more output devices (e.g., output device(s) 3120 and 3520, respectively), one or more processors (e.g., processor(s) 3130 and 3530, respectively), and/or one or more memory storage devices (e.g., memory storage device(s) 3140 and 3540, respectively). Examples of input device(s) 3110 and 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3120 and 3520 can include one or more monitors, one or more touch screen displays, projectors, monitor 106 (FIG. 1), screen 108 (FIG. 1), etc. Other examples of output device(s) 3120 and 3520 can include other I/O device 222 (FIG. 2), network adapter 220, wireless transmitters, wired transmitters, and the like. Examples of processor(s) 3130 and 3530 can include CPU 210 (FIG. 2), etc. Examples of memory storage device(s) 3140 and 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3110 and/or 3510 further can include one or more cameras and/or one or more microphones. In the same or different embodiments, input device(s) 3110 and/or 3510 can include one or more GPS (Global Positioning System) sensor(s) (e.g., GPS sensor(s) 3511), one or more accelerometers (e.g., accelerometer(s) 3512), one or more gyroscopes (e.g., gyroscope(s) 3513), and/or one or more magnometers, among other input devices.

Input device(s) 3510 and output device(s) 3520 can be coupled to first user device(s) 350 in a wired manner and/or a wireless manner, and the coupling can be direct and/or indirect, as well as locally and/or remotely. Similarly, input device(s) 3110 and output device(s) 3120 can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3110 and output device(s) 3120 to processor(s) 3130 and/or memory storage device(s) 3140. In some embodiments, the KVM switch also can be part of system 310. In a similar manner, processor(s) 3130 and/or memory storage device(s) 3140 can be local and/or remote to each other.

In certain embodiments, the user devices (e.g., first user device(s) 350) can be mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart contacts, smart watches, smart rings, smart bracelets, other smart jewelry, smart headbands, augmented-reality (AR) headsets, virtual-reality (VR) headsets, etc.), or another portable computer device with the capability to present audio and/or visual data (e.g., images, videos, music, etc.). Thus, in some examples, a mobile device can include a volume and/or weight sufficiently small as to permit the mobile device to be easily conveyable by hand.

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, (iv) a Galaxy™ Tab, Smartphone or Ring or similar product by the Samsung Group of Samsung Town, Seoul, South Korea, and/or (v) an Oura® Ring or similar product by Oura Health Oy of Oulu, Finland. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

Meanwhile, in some embodiments, first user device(s) 350 also can be configured to communicate with one or more databases (e.g., a database(s) 330) and/or one or more remote server(s) 320. The one or more databases can include a member database that contains information about the demographic and/or geographic information of members of a population (e.g., insurance policyholders for an insurance company, etc.). The demographic and/or geographic information of the members can include the ages, genders, residences, insurance policies, premiums, payment history, and/or claim histories for the members, for example, among other information. The same or different databases can include telematics data for such members, and/or electronic ledgers related to the telematics data. The one or more databases also can include real-time data, static data, historical data, static risk data, and historic risk data. The one or more databases additionally can include one or more of trained machine learning (ML) and/or artificial intelligence (AI) models (the ML/AI models) used in system 300, remote server(s) 320, first user device(s) 350, and/or system 310. The one or more databases further can include training datasets for various ML/AI models, modules, or systems. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, first user device(s) 350, system 310, remote server(s) 320, and/or database(s) 330 can be implemented using any suitable manner of wired and/or wireless communication. Accordingly, system 300, first user device(s) 350, system 310, and/or database(s) 330 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc.; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

In some embodiments, remote server(s) 320, first user device(s) 350, and/or system 310 can be configured to transmit, to a user device (e.g., system 310 transmit to first user device(s) 350, or first user device(s) 350 transmit to remote server(s) 320, etc.) of a user, or to a graphical user interface (e.g., a webpage, a graphical user interface of a mobile application, etc.) for display on the user device. The graphical user interface can include statistics, warnings, recommendations, notices, motivational messages, requests for user confirmation, discounts for insurance premiums, travel directions, travel route recommendations, and the like. Remote server(s) 320, first user device(s) 350, and/or system 310 can determine, by using any suitable approaches or ML/AI models, the statistics, warnings, recommendations, notices, motivational messages, requests, discounts, directions, and other information. Algorithms for the ML/AI models for determining the information can include decision trees, K Nearest Neighbor (KNN), neural networks, CatBoost, support vector machine, etc.

As an example, referring to FIG. 3, reception module 3141 of memory storage device(s) 3140 of system 310 can be configured to receive real-time, static, modeled and other data related to driving conditions, vehicle status, etc. Modeled data module 3142 of memory storage device(s) 3140 of system 310 can be configured to generate the modeled data by analyzing the real-time and static data, the historical vehicle telemetry, etc. and predicting current vehicle component conditions, etc. Potential routes module 3143 of memory storage device(s) 3140 of system 310 can be configured to identify different routes and/or different route segments from a first location to a destination. Risk assessments module 3144 of memory storage device(s) 3140 of system 310 can be configured to identify safety risks and hazards (i.e., conduct a risk assessment, generate a risk score, etc.) associated with the different routes and/or different route segments and based on the real-time static, modeled, and other data. Identified route module 3145 of memory storage device(s) 3140 of system 310 can be configured to determine a route that minimizes identified risks and hazards within certain parameters or under certain conditions, and can be configured to dynamically update the identified route based on changes in real-time data during travel along the identified route. Transmission module 3146 of memory storage device(s) 3140 of system 310 can be configured to transmit the identified route to a mobile device. A graphical user interface (GUI) on output device(s) 3520 of user device(s) 350 can be configured to provide the identified route and related risks to a user.

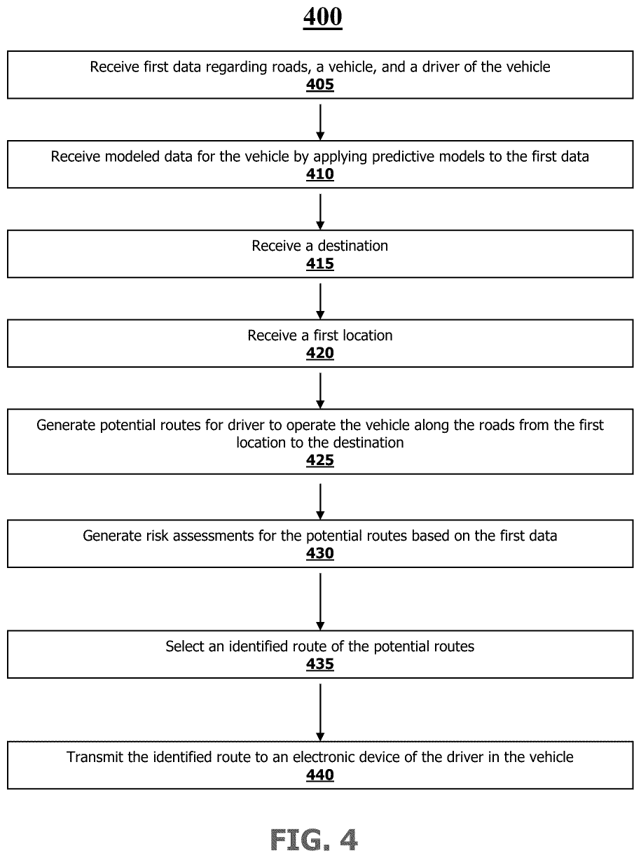

Turning ahead in the drawings, FIG. 4 illustrates a flow chart of a method 400 for generating travel routes, which can include reducing risk to keep drivers and/or passengers in vehicles safer, reducing risk to keep vehicles safer, reducing risk to keep people on the roadside safer, reducing wear and tear on certain roads, reducing wear and tear on vehicles, recommending vehicle maintenance, coaching to reduce unsafe driving behaviors, recommending vehicles for purchase, recommending billboard locations and other roadside advertisement locations, providing insurance discounts, and lowering credit scores, according to certain embodiments. Method 400 can be implemented via execution of computing instructions configured to run on one or more processors and stored on one or more non-transitory computer-readable media, and/or via one or more ASICs. Method 400 is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined together or skipped.

In some embodiments, system 300 (FIG. 3) or system 310 (FIG. 3) (including one or more of its elements, modules, and/or systems, such as reception module 3141 (FIG. 3), modeled data module 3142 (FIG. 3), potential routes module 3143 (FIG. 3), risk assessments module 3144 (FIG. 3), identified route module 3145 (FIG. 3), and transmission module 3146 (FIG. 3) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), first user device(s) 350 (FIG. 3), system 310 (FIG. 3). The processor(s) can be similar or identical to the processor(s) described above with respect to computer system 100 (FIG. 1), processor(s) 3530 (FIG. 3), and/or processor(s) 3130 (FIG. 3).

Referring to FIG. 4, in some embodiments, method 400 can be implemented via execution of computing instructions configured to run on one or more processors and stored on one or more non-transitory computer-readable media. More specifically, method 400 can include a block 405 of receiving first data regarding roads, a vehicle, and a user of the vehicle. Receiving the first data can include passively receiving, and/or can include actively receiving, such as accessing or retrieving the first data, as well as continuously or periodically monitoring the first data during travel along a route. As an example, block 405 can be performed by system 310 (FIG. 3).

In some embodiments, block 405 can include receiving real-time data related to current conditions of the roads, and when receiving the first data includes receiving the real-time data, the first data includes the real-time data. As an example, the current conditions of the roads can include traffic data or conditions, road construction data or conditions, and/or weather data or conditions. The current conditions of the roads can be received, accessed, or retrieved from connected vehicle sensors, traffic monitoring systems, and weather monitoring systems.

In some embodiments, block 405 also can include receiving static data related to physical characteristics of the roads, and when receiving the first data includes receiving the static data, the first data includes the static data. As an example, the physical characteristics of the roads can be fixed characteristics of the roads, such as road structures, road pitch, road yaw, speed limits, school zone locations (in addition to time of day, day of week, and day of month, information), road grades, road curvatures, presence of intersections, and gross vehicle weight ratings (GVWR). The physical characteristics of the roads can be received, accessed, or retrieved from mapping databases, and national and local government databases.

In some embodiments, block 405 also can include receiving historical data related to past road conditions and past accidents on the roads, and when receiving the first data includes receiving the historical data, the first data includes the historical data. As an example, the historical data can include accident frequency data for road segments and intersections.

In some embodiments, block 405 also can include receiving driver profile data for the user of the vehicle, and when receiving the first data includes receiving the driver profile data, the first data includes the driver profile data. As an example, the driver profile data can include historical driving behavior for the user. The historical driving behavior for the user can be based on GPS data. In some embodiments, one or more smartphones can use one or more of its sensors to collect the GPS data. The one or more sensors can include any of one or more of GPS sensors, accelerometers, gyroscopes, or magnometers; and the GPS data can include any of one or more of GPS data, accelerometer data, gyroscope data, or magnometer data. In other embodiments, the vehicle's infotainment and/or telematics system can use one or more of its sensors to collect the GPS data. Again, the one or more first sensors can include GPS sensors, accelerometers, gyroscopes, and/or magnometers, and the GPS data can include any of one or more of GPS data, accelerometer data, gyroscope data, and/or magnometer data. In any of these embodiments, the GPS data can include data regarding speed, acceleration, deceleration, elevation, incline, decline, pitch, yaw, etc.; accelerometer data can include data regarding acceleration, deceleration, etc.; gyroscope data can include data regarding incline, decline, pitch, yaw, etc.; and magnometer data can include the strength and direction of a magnetic field, often measured along three axes (x, y, and z), providing information about the total magnetic field strength at a specific location, often accompanied by corresponding geographic coordinates like latitude and longitude to pinpoint the measurement area.

In some embodiments, block 405 also can include receiving vehicle condition data for the vehicle, and when receiving the first data includes receiving the vehicle condition data, the first data includes the vehicle condition data. As an example, the vehicle condition data can include tire tread wear or thickness, break pad wear or thickness, etc. The vehicle condition data can be measured during a vehicle maintenance check-up or at other times.

When system 310 (FIG. 3) collects the above-mentioned data (e.g., real-time data, static data, historical data, driver profile data, and vehicle condition data) from a variety of sources, system 310 (FIG. 3) can revise the data format of such data into a common data format so that system 310 (FIG. 3) stores such data in the common data format in memory storage device(s) 3140 (FIG. 3) and/or database(s) 330 (FIG. 3). This common data format permits system 310 (FIG. 4) to more efficiently use the stored data in method 400.

Next, method 400 in FIG. 4 can continue with a block 410 of receiving modeled data for the vehicle, where the modeled data is generated by at least applying at least one predictive model to the first data. Receiving the modeled data can include passively receiving, and also can include actively receiving, such as accessing or retrieving the modeled data, as well as providing or generating the modeled data, and/or continuously or periodically monitoring the modeled data during travel along a route. The at least one predictive model can include machine learning models.

In some embodiments, the modeled data can be receiving from a third party or from another module or component within system 310 and/or system 300. As an example, the modeled data can include current tire tread depth, current break pad thickness, etc., and the one or more predictive models can be applied to the real-time data, the static data, the historical data, the driver profile data, and/or the vehicle condition data, as converted into the one or more common data formats. As a further example, block 410 can estimate current vehicle condition parameters based on historical vehicle maintenance data and recent vehicle usage data, where the estimated current vehicle condition parameters can include estimated tire wear, estimated tread wear, estimated brake conditions, etc. The modeled data also can be generated by using machine learning to analyze historical vehicle telemetry data, and to predict current vehicle component conditions based on the vehicle condition data, historical vehicle telemetry data, recent driving patterns, and a portion of the static data based on the historical vehicle telemetry data.

Vectors can be used to represent the various data, and the machine learning can analyze the vectors to generate the modeled data. For example, each type of data (real-time, static, historical, etc.) can be encoded into numerical vector representations. Real-time data vectors can include elements representing current traffic density, weather conditions, road surface conditions, and ongoing construction activities. Static data vectors can contain elements describing road characteristics such as number of lanes, speed limits, curve radii, elevation changes, and presence of traffic control devices. Historical data vectors can include elements representing past accident frequencies, typical traffic patterns, and seasonal variations in road conditions. These vectors can be combined or concatenated to create comprehensive input vectors for machine learning models. The machine learning algorithms, which can include neural networks, decision trees, or ensemble methods, can then process these input vectors to identify patterns, correlations, and complex relationships between different data elements. The machine learning algorithms also can learn from historical outcomes to predict future risks or conditions, and generate new vectors representing the modeled data, which can include predicted risk scores for different road segments under current conditions, estimated vehicle performance metrics based on road conditions and vehicle maintenance history, and projected traffic patterns or accident likelihoods for upcoming time periods. The resulting modeled data vectors can then be integrated with the original input data to provide a more comprehensive basis for route risk assessment. This vector-based approach allows for efficient processing of multi-dimensional data and enables the machine learning models to capture nuanced interactions between various factors affecting route safety and efficiency.

Subsequently, method 400 in FIG. 4 can continue with a block 415 of receiving a destination, and a block 420 of receiving a first location. As an example, the destination can be received from the user who enters the destination into a user interface on the mobile device. As another example, the first location can be the current location or a starting location. The first location can be automatically calculated or determined using GPS data from the mobile device or the vehicle's infotainment and/or telematics system.

Then, method 400 can continue with a block 425 of generating potential routes for the driver to operate the vehicle along the roads from the first location to the destination. As an example, block 425 can identify a network of roads connecting the first location to the destination, as well as determine multiple possible road combinations through the network of roads. The determination can consider various road types including highways, major arterials, secondary roads, and local streets. The determination also can take into account any user preferences or constraints, such as avoiding toll roads or maximizing highway usage. The determination also can evaluate route options that prioritize different factors such as distance, estimated travel time, or number of turns. The determination can further incorporate any intermediate waypoints or stops requested by the user.

Afterwards, method 400 can continue with a block 430 of generating risk assessments for the potential routes based on the first data. In some embodiments, generating the risk assessments can include customizing the risk assessments based on the user and the vehicle such that the risk assessments based on a different user or a different vehicle are different risk assessments than when based on the user and the vehicle. Generating the risk assessments for the potential routes can include generating the risk assessments for road segments along the potential routes, where each potential route can include one or more road segments. The risk assessments can be based on the real-time data, the static data, the historical data, the driver profile data, and the vehicle condition data. The real-time data, the static data, and the modeled data can be analyzed using machine learning to identify safety risks and hazards along the potential routes and/or along the road segments of the potential routes. As an example, if a road segment satisfies a safety threshold, then the risk assessment for the road segment can stop, and the risk assessment for a potential route can be a combination of the risk assessments of all road segments for that potential route. Vectors can be used to represent the various data, and the machine learning can analyze the vectors to generate the risk assessments.

In some embodiments, generating the risk assessment for a route can include analyzing each segment of the route using the real-time, static, historical, driver profile, vehicle condition, and modeled data, as well as identifying potential hazards or risk factors along the route. Generating the risk assessment for the route also can include evaluating the severity and likelihood of each identified risk, and considering how the risks may interact with the specific driver's historical behavior patterns and the current vehicle condition, as well as accounting for time-of-day, day-of-week, day-of-month, and day-of year factors that may influence risk levels, such as rush hour traffic, nighttime driving conditions, winter versus summer seasons, and holidays. Generating the risk assessment for the route also can include assessing how well the driver's skills and tendencies align with the requirements of the route, as well as synthesizing all these factors to produce either a quantitative count of distinct risks or a holistic risk score for the entire route.

Next, method 400 can continue with a block 435 of selecting an identified route of the potential routes. In some embodiments, selecting the identified route can include customizing the identified route for the user and the vehicle such that the identified route for the different user or for the different vehicle is a different route than for the user and the vehicle. As an example, the identified route can have at least one of fewer risks or lower risks compared to one or more other routes of the potential routes and based on the risk assessments for the potential routes. Selecting the identified route can include determining an identified route of the potential routes. The determination can include dynamically updating a route of the potential routes to be the identified route based on changes in the real-time data. As explained further below, the determination also can be based on (a) a balancing of the estimated travel time and the assessed risk, (b) a lowest risk level, (c) a lowest risk quantity, (d) a lowest risk assessment, (e) a risk assessment below a risk threshold, etc.

Subsequently, method 400 can continue with a block 440 of transmitting the identified route to an electronic device of the user. A graphical user interface of the electronic device of the user can display the identified route or information about the identified route for the user. In some embodiments, the user can be in the vehicle, and can be an operator of the vehicle or a non-operator of the vehicle. In some embodiments, the transmitting can occur while the user is operating the vehicle or before the trip begins. Block 440 can include transmitting alerts to the electronic device of the user about specific hazards or risks along the identified route before the trip beings and/or during the trip. Block 440 also can include transmitting a warning or other alert to the electronic device of the user that the identified route is slower than the driver-specified time of arrival or preference, but is safer. Block 440 also can include transmitting to the electronic device of the user a warning or other alert that the identified route includes (a) a road segment having a risk level above a predetermined threshold, and/or (b) a risk resulting in the risk level being above the predetermined threshold.

In some embodiments, the performance of the sequence of blocks 420, 425, 430, 435, and 440 can be repeated over and over during the vehicle trip to account for real-time changes in weather conditions, road conditions, traffic conditions, and so on. In some embodiments, the repetition of the sequence of blocks 420, 425, 430, 435, and 440 can occur, if at all, only periodically. In other embodiments, the repetition of the sequence of blocks 420, 425, 430, 435, and 440 can occur continuously. During any of these repetitions, in some embodiments, less than the entire sequence of blocks can be repeated based on user input or feedback and/or based on predetermined conditions. For example, in some embodiments, during any repetition of the sequence of blocks 420, 425, 430, 435, and 440, the sequence can stop at block 430 if the generated risk assessments have not changed since the original calculation or since the last repetition.

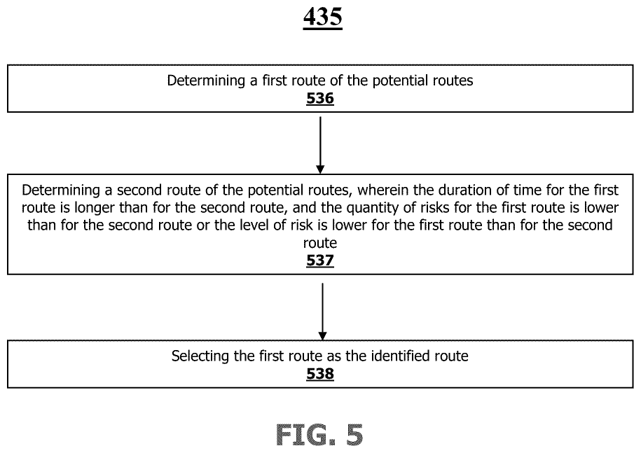

Turning to the next drawing, FIG. 5 illustrates a flow chart for a first embodiment of block 435 of method 400 in FIG. 4. Block 435 is not limited to the embodiments presented in FIG. 5. Block 435 can be employed in many different embodiments or examples not specifically depicted or described herein.

In some embodiments, the procedures, the processes, the operations, the actions, and/or the activities of block 435 can be performed in the order presented. In other embodiments, the procedures, the processes, the operations, the actions, and/or the activities of block 435 can be performed in any suitable order. In still other embodiments, one or more of the procedures, the processes, the operations, the actions, and/or the activities of block 435 can be combined together or skipped.

Referring to FIG. 5, block 435 can include a block 536 for determining a first route of the potential routes. The first route can include a first duration of time and also can include at least one of a first quantity of risks or a first level risk based on a risk assessment of the risk assessments for the first route. The first duration of time can represent the estimated travel time for the first route, taking into account factors such as distance, speed limits, historical traffic patterns, and current real-time traffic conditions. The first quantity of risks can refer to the number of identified risk factors along the first route, which can include hazardous intersections, areas prone to accidents, road segments with poor maintenance history, or zones with frequent weather-related incidents. The first level risk can be a composite risk score calculated for the entire route, which aggregates and weighs various risk factors identified through the risk assessment process.

Next, block 435 in FIG. 5 can include a block 537 for determining a second route of the potential routes. The second route can include a second duration of time and also can include at least one of a second quantity of risks or a second level risk based on a risk assessment of the risk assessments for the second route. The second duration of time can represent the estimated travel time for the second route, taking into account factors such as distance, speed limits, historical traffic patterns, and current real-time traffic conditions. The second quantity of risks can refer to the number of identified risk factors along the second route, which can include hazardous intersections, areas prone to accidents, road segments with poor maintenance history, or zones with frequent weather-related incidents. The second level risk can be a composite risk score calculated for the entire route, which aggregates and weighs various risk factors identified through the risk assessment process.

In some embodiments, the first duration of time for the first route in block 536 is longer than the second duration of time for the second route in block 537. Additionally, in some embodiments, at least one of the first quantity of risks for the first route in block 536 is lower than the second quantity of risks for the second route in block 537, or the first level of risk for the first route in block 536 is lower than the second level of risk for the second route in block 537.

Continuing with the flow chart in FIG. 5, block 435 can further include a block 538 for selecting the first route as the identified route. In the embodiment of block 435 in FIG. 5, the first route can be selected because it is less risky than the second route, even though the first route is slower than the second route.

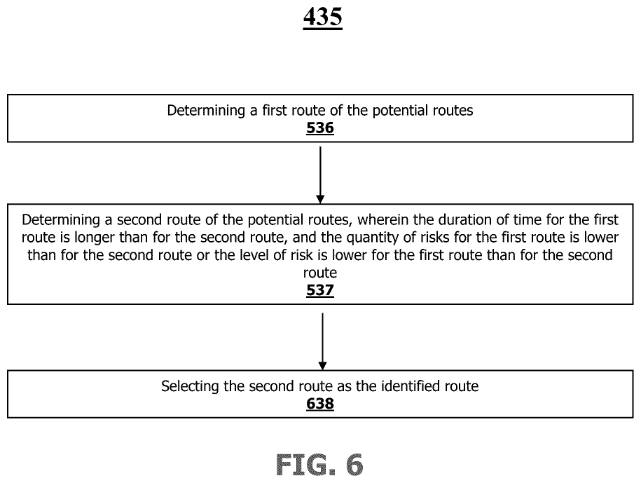

Turning to the next figure, FIG. 6 illustrates a flow chart for a second embodiment of block 435 of method 400 in FIG. 4. Block 435 is not limited to the embodiments presented in FIG. 6. Block 435 can be employed in many different embodiments or examples not specifically depicted or described herein.

In some embodiments, the procedures, the processes, the operations, the actions, and/or the activities of block 435 can be performed in the order presented. In other embodiments, the procedures, the processes, the operations, the actions, and/or the activities of block 435 can be performed in any suitable order. In still other embodiments, one or more of the procedures, the processes, the operations, the actions, and/or the activities of block 435 can be combined together or skipped.

Referring to FIG. 6, block 435 can include block 536 and block 537. Accordingly, in some embodiments, the beginning of block 435 in FIG. 6 can be similar to or the same as the beginning of block 435 in FIG. 5.

However, in FIG. 6, after block 537, block 435 can include a block 638 for selecting the second route as the identified route. (Block 638 in FIG. 6 is different from block 538 in FIG. 5, which selects the first route as the identified route.) In the embodiment of block 435 in FIG. 6, the second route can be selected even though it is riskier than the first route because the first route is too slow or exceeds a time threshold or a maximum time limit for travel. As an example, the first duration of time for the first route can be longer than a predetermined maximum duration of time defined by the user, and the second duration of time can be shorter than the predetermined maximum duration of time.

When the embodiment of block 435 in FIG. 6 is used, method 400 (FIG. 4) can operate slightly differently than what was originally described above with reference to FIG. 4. More specifically, method 400 (FIG. 4) can include determining that an identified route of the potential routes has a lowest risk score and an estimated travel time exceeding a time threshold and, subsequently in response thereto, can include generating an alternate route (or identifying a different route of the potential routes) having a lower estimated travel time and a higher risk score.

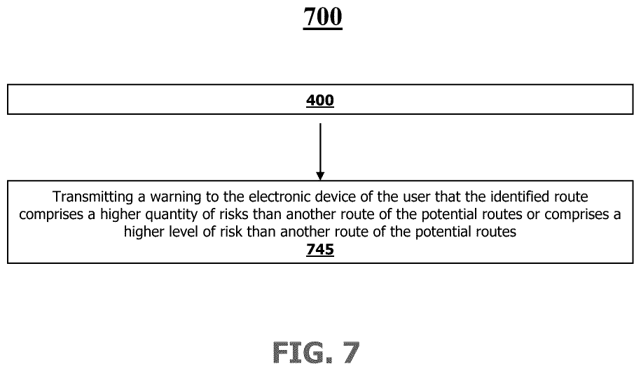

Turning to the next drawing, FIG. 7 illustrates a flow chart of a method 700 for generating travel routes, which can include reducing risk to keep drivers and/or passengers in vehicles safer, reducing risk to keep vehicles safer, reducing risk to keep people on the roadside safer, reducing wear and tear on certain roads, reducing wear and tear on vehicles, recommending vehicle maintenance, coaching to reduce unsafe driving behaviors, recommending vehicles for purchase, recommending billboard locations and other roadside advertisement locations, providing insurance discounts, and lowering credit scores, according to certain embodiments. Method 700 can be implemented via execution of computing instructions configured to run on one or more processors and stored on one or more non-transitory computer-readable media, and/or via one or more ASICs. Method 700 is not limited to the embodiments presented herein. Method 400 can be employed in many different embodiments or examples not specifically depicted or described herein.

In some embodiments, the procedures, the processes, the operations, the actions, and/or the activities of method 700 can be performed in the order presented. In other embodiments, the procedures, the processes, the operations, the actions, and/or the activities of method 700 can be performed in any suitable order. In still other embodiments, one or more of the procedures, the processes, the operations, the actions, and/or the activities of method 700 can be combined together or skipped.

In some embodiments, system 300 (FIG. 3) or system 310 (FIG. 34) (including one or more of its elements, modules, and/or systems, such as reception module 3141 (FIG. 3), modeled data module 3142 (FIG. 3), potential routes module 3143 (FIG. 3), risk assessments module 3144 (FIG. 3), identified route module 3145 (FIG. 3), and transmission module 3146 (FIG. 3) can be suitable to perform method 700 and/or one or more of the operations, actions, and/or activities of method 700. In these or other embodiments, one or more of the operations, actions, and/or activities of method 700 can be implemented as one or more computing instructions configured to run on one or more processors and configured to be stored on one or more non-transitory computer readable media, and/or as one or more ASICs. Such non-transitory computer readable media can be part of a computer system such as system 300 (FIG. 3), first user device(s) 350 (FIG. 3), system 310 (FIG. 3). The processor(s) can be similar or identical to the processor(s) described above with respect to computer system 100 (FIG. 1), processor(s) 3530 (FIG. 3), and/or processor(s) 3130 (FIG. 3).

Referring to FIG. 7, in some embodiments, method 700 can be implemented via execution of computing instructions configured to run on one or more processors and stored on one or more non-transitory computer-readable media. More specifically, method 700 can include method 400. When method 700 includes the second embodiment of block 435 of method 400, as discussed above with reference to FIG. 6, method 700 can continue after method 400 with a block 745 for transmitting a warning to the electronic device of the user. A graphical user interface of the electronic device of the user can display the warning for the user.

The warning can indicate that the identified route comprises a higher quantity of risks than another route of the potential routes or comprises a higher level of risk than another route of the potential routes. More specifically, the selected second route is riskier than the unselected first route, as noted above with reference to FIG. 6.

In some embodiments, when block 745 is performed and the warning is displayed to the user via the graphical user interface of the user, the user can be in the vehicle, and can be an operator of the vehicle or a non-operator of the vehicle. In some embodiments, the transmitting can occur while the user is operating the vehicle or before the trip begins. Block 745 can include transmitting warning to the electronic device of the user about specific hazards or risks along the identified route before the trip beings and/or during the trip. Block 745 also can include transmitting a warning or other alert to the electronic device of the user that the identified route is slower than the driver-specified time of arrival or preference, but is safer. Block 745 also can include transmitting to the electronic device of the user a warning or other alert that the identified route includes (a) a road segment having a risk level above a predetermined threshold, and/or (b) a risk resulting in the risk level being above the predetermined threshold.

Relating FIGS. 4, 5, 6, and 7 to FIGS. 1, 2, and 3, as an example, input device(s) 3510, output device(s) 3520, processor(s) 3530, and/or memory storage device(s) 3540 (FIG. 3) can perform all or a portion of block 405 (FIG. 4); input device(s) 3110 (FIG. 3) can perform all or a portion of blocks 405, 410, 415, and/or 420 (FIG. 4); processor(s) 3130 and memory storage device(s) 3140 (FIG. 3) can perform all or portions of blocks 405, 410, 415, 420, 425, 430, 435, 440 (FIG. 4), 536, 537, 538 (FIG. 5), 638 (FIG. 6), and/or 745 (FIG. 7); output device(s) 3120 (FIG. 3) can perform all or a portion of blocks 440 (FIG. 4) and/or 745 (FIG. 7); remote server(s) 320 (FIG. 3) can perform all or portions of blocks 405, 410, 415, 420, 425, 430, 435, 440 (FIG. 4), 536, 537, 538 (FIG. 5), 638 (FIG. 6), and/or 745 (FIG. 7); database(s) 330 can perform all or portions of blocks 405, 410, 415, 420, 425, 430, 435, 440 (FIG. 4), 536, 537, 538 (FIG. 5), 638 (FIG. 6), and/or 745 (FIG. 7); reception module 3141 can perform all or a portion of blocks 405, 410, 415, and/or 420 (FIG. 4); modeled data module 3142 (FIG. 3) can perform all or a portion of block 410 (FIG. 4); potential routes module 3143 (FIG. 3) can perform all or a portion of block 425 (FIG. 4); risk assessments module 3144 (FIG. 3) can perform all or a portion of block 430 (FIG. 4); identified route module 3145 (FIG. 3) can perform all or a portion of block 435 (FIG. 4), 536, 537, 538 (FIG. 5), and/or 638 (FIG. 6); and transmission module 3146 (FIG. 3) can perform all or a portion of blocks 440 (FIG. 4) and/or 745 (FIG. 7).

In a number of embodiments where one or more ML/AI models are used in blocks 410, 425, 430, and/or 435 (FIG. 4), methods 400 (FIG. 4) and/or 700 (FIG. 7) further can include pre-training and/or re-training the trained ML/AI models based upon the collected sensor data from blocks 405 and/or 420 (FIG. 4), feedback received from a system user (e.g., a data scientist, a machine learning engineer, etc.) or collected from various data sources (e.g., telematics databases, policy renewal rates, insurance claim trends, insurance premium trends, insurance premium discount trends, etc.), and/or synthesized training data. In these embodiments, the same or different ML/AI models can be used in one or more of blocks 410, 425, 430, and/or 435 (FIG. 4).

For each of the machine learning models to be retrained, the respective training datasets can be updated manually by a system user (e.g., an ML engineer, a data scientist, etc.) and/or automatically by a system (e.g., system 300, system 310, or remote server(s) 320 (FIG. 3)). The system user can select new training data from various data sources (e.g., websites, books, magazines, product catalogs, private third-party databases, etc.). The system can collect new training data based upon various criteria. In certain embodiments, historical input and/or output data of the model to be re-trained can be used for re-training the model. In several embodiments, the historical input and/or output data of the model can be selected based upon system performance and/or user feedback from the system user associated with the historical output data. Examples of the user feedback can include when the machine learning model incorrectly identifies a travel route that is not acceptable to a user, and so forth. In various embodiments, when more than one training dataset is used for the pre-training and/or re-training, the system (e.g., system 300, system 310, and/or remote server(s) 320 (FIG. 3)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, customized classifiers can be trained, retrained, and stored locally on the one or more first electronic devices. As another example, one or more of these customized classifiers can be trained and/or retrained remotely (e.g., at the one more first electronic devices, the remote servers, etc.) and stored locally.

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pre-training transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In some embodiments, the systems and/or methods can be configured to train or re-train the one or more ML/AI models. The training of each of the ML/AI models can be supervised, semi-supervised, and/or unsupervised—which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In some embodiments, the trained and/or re-trained ML/AI model as well as the training datasets can be stored in, updated, and accessed from a database (e.g., database(s) 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In some embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

Although systems and methods for collecting data have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-7 can be modified, and that the foregoing discussion of certain of these embodiments does not necessarily represent a complete description of all possible embodiments. Additionally, one or more of the procedures, processes, operations, actions, and/or activities of the methods in FIGS. 4, 5, 6, and 7 can include different procedures, processes, actions, and/or activities and be performed by many different modules, in many different orders. For example, each of the blocks in the different embodiments of method 400 (FIGS. 4, 5, and 6) and/or method 700 (FIG. 7) can be performed before a vehicle trip, at the beginning of a vehicle trip, in the middle of the vehicle trip, at the end of the vehicle trip, or after the vehicle trip. Additionally, the systems and methods described herein use multi-variate processes, but also can use mono-variate processes. Furthermore, the systems and methods are described herein for generating vehicle routes, but also can be used for generating walking routes based on risk assessments, for generating biking routes based on risk assessments, etc.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method being implemented via execution of computing instructions configured to run on one or more processors and stored on one or more non-transitory computer-readable media, the method comprising:
receiving first data regarding roads, a vehicle, and a user of the vehicle;
receiving modeled data for the vehicle, wherein the modeled data is generated at least by applying at least one predictive model to the first data;
receiving a destination;
receiving a first location;
generating potential routes for the user to operate the vehicle along the roads from the first location to the destination;
generating risk assessments for the potential routes based on the first data;
selecting an identified route of the potential routes, wherein the identified route comprises at least one of fewer risks or lower risks compared to one or more other routes of the potential routes and based on the risk assessments for the potential routes; and
transmitting the identified route to an electronic device of the user.

2. The method of claim 1, wherein:
receiving the first data comprises one or more of:
receiving real-time data related to current conditions of the roads;
receiving static data related to physical characteristics of the roads;
receiving historical data related to past road conditions and past accidents on the roads;
receiving driver profile data for the user of the vehicle; or
receiving vehicle condition data for the vehicle;
when receiving the first data comprises receiving the real-time data, the first data comprises the real-time data;
when receiving the first data comprises receiving the static data, the first data comprises the static data;
when receiving the first data comprises receiving the historical data, the first data comprises the historical data;
when receiving the first data comprises receiving the driver profile data, the first data comprises the driver profile data; and
when receiving the first data comprises receiving the vehicle condition data, the first data comprises the vehicle condition data.

3. The method of claim 1, wherein:
selecting the identified route of the potential routes further comprises:
determining a first route of the potential routes, wherein the first route comprises a first duration of time and also comprises at least one of a first quantity of risks or a first level of risk based on a risk assessment of the risk assessments for the first route;
determining a second route of the potential routes, wherein the second route comprises a second duration of time and also comprises at least one of a second quantity of risks or a second level of risk based on a risk assessment of the risk assessments for the second route, wherein the first duration of time is longer than the second duration of time, and wherein at least one of the first quantity of risks is lower than the second quantity of risks or the first level of risk is lower than the second level of risk; and
selecting the first route as the identified route.

4. The method of claim 1, wherein:
selecting the identified route of the potential routes further comprises:
determining a first route of the potential routes, wherein the first route comprises a first duration of time and also comprises at least one of a first quantity of risks or a first level of risk based on a risk assessment of the risk assessments for the first route; and
determining a second route of the potential routes, wherein the second route comprises a second duration of time and also comprises at least one of a second quantity of risks or a second level of risk based on a risk assessment of the risk assessments for the second route, wherein the first duration of time is longer than the second duration of time, and wherein at least one of the first quantity of risks is lower than the second quantity of risks or the first level of risk is lower than the second level of risk; and
selecting the second route as the identified route.

5. The method of claim 4, further comprising:
transmitting a warning to the electronic device of the user that the identified route comprises a higher quantity of risks than another route of the potential routes or comprises a higher level of risk than another route of the potential routes.

6. The method of claim 4, wherein:
the first duration of time is longer than a predetermined maximum duration of time; and
the second duration of time is shorter than the predetermined maximum duration of time.

7. The method of claim 1, wherein:
generating the risk assessments for the potential routes based on the first data further comprises:
customizing the risk assessments for the potential routes based on the user and the vehicle such that a risk assessment based on a different user or a different vehicle is a different risk assessment than when based on the user and the vehicle; and
selecting the identified route of the potential routes further comprises:
customizing the identified route for the user and the vehicle such that an identified route for the different user or for the different vehicle is a different route than for the user and the vehicle.

8. A system comprising:
one or more processors; and
one or more non-transitory computer-readable media storing computing instructions that, when run on the one or more processors, cause the one or more processors to perform:
receiving first data regarding roads, a vehicle, and a user of the vehicle;
receiving modeled data for the vehicle, wherein the modeled data is generated at least by applying at least one predictive model to the first data;
receiving a destination;
receiving a first location;
generating potential routes for the user to operate the vehicle along the roads from the first location to the destination;
generating risk assessments for the potential routes based on the first data;
selecting an identified route of the potential routes, wherein the identified route comprises at least one of fewer risks or lower risks compared to one or more other routes of the potential routes and based on the risk assessments for the potential routes; and
transmitting the identified route to an electronic device of the user.

9. The system of claim 8, wherein:
receiving the first data comprises one or more of:
receiving real-time data related to current conditions of the roads;
receiving static data related to physical characteristics of the roads;
receiving historical data related to past road conditions and past accidents on the roads;
receiving driver profile data for the user who operates the vehicle; or
receiving vehicle condition data for the vehicle;
when receiving the first data comprises receiving the real-time data, the first data comprises the real-time data;
when receiving the first data comprises receiving the static data, the first data comprises the static data;
when receiving the first data comprises receiving the historical data, the first data comprises the historical data;
when receiving the first data comprises receiving the driver profile data, the first data comprises the driver profile data; and
when receiving the first data comprises receiving the vehicle condition data, the first data comprises the vehicle condition data.

10. The system of claim 8, wherein:
selecting the identified route of the potential routes further comprises:
determining a first route of the potential routes, wherein the first route comprises a first duration of time and also comprises at least one of a first quantity of risks or a first level of risk based on a risk assessment of the risk assessments for the first route;
determining a second route of the potential routes, wherein the second route comprises a second duration of time and also comprises at least one of a second quantity of risks or a second level of risk based on a risk assessment of the risk assessments for the second route, wherein the first duration of time is longer than the second duration of time, and wherein at least one of the first quantity of risks is lower than the second quantity of risks or the first level of risk is lower than the second level of risk; and
selecting the first route as the identified route.

11. The system of claim 8, wherein:
selecting the identified route of the potential routes further comprises:
determining a first route of the potential routes, wherein the first route comprises a first duration of time and also comprises at least one of a first quantity of risks or a first level of risk based on a risk assessment of the risk assessments for the first route; and
determining a second route of the potential routes, wherein the second route comprises a second duration of time and also comprises at least one of a second quantity of risks or a second level of risk based on a risk assessment of the risk assessments for the second route, wherein the second duration of time is longer than the first duration of time, and wherein at least one of the first quantity of risks is lower than the second quantity of risks or the first level of risk is lower than the second level of risk; and
selecting the second route as the identified route.

12. The system of claim 11, wherein the instructions, when run on the one or more processors, further cause the one or more processors to perform:
transmitting a warning to the electronic device of the user that the identified route comprises a higher quantity of risks than another route of the potential routes or comprises a higher level of risk than another route of the potential routes.

13. The system of claim 11, wherein:
the first duration of time is longer than a predetermined maximum duration of time; and
the second duration of time is shorter than the predetermined maximum duration of time.

14. The system of claim 8, wherein:
generating the risk assessments for the potential routes based on the first data further comprises:
customizing the risk assessments for the potential routes based on the user and the vehicle such that a risk assessment based on a different user or a different vehicle is a different risk assessment than when based on the user and the vehicle; and
selecting the identified route of the potential routes further comprises:
customizing the identified route for the user and the vehicle such that an identified route for the different user or the different vehicle is a different route than for the user and the vehicle.

15. A non-transitory computer readable storage medium storing computing instructions, the computing instructions, when run on one or more processors, causing the one or more processors to perform:
receiving first data regarding roads, a vehicle, and a user of the vehicle;
generating modeled data for the vehicle, wherein the modeled data is generated at least by applying at least one predictive model to the first data;
receiving a destination;
receiving a first location;
generating potential routes for the user to operate the vehicle along the roads from the first location to the destination;
generating risk assessments for the potential routes based on the first data;
selecting an identified route of the potential routes, wherein the identified route comprises at least one of fewer risks or lower risks compared to one or more other routes of the potential routes and based on the risk assessments for the potential routes; and
transmitting the identified route to an electronic device of the user.

16. The non-transitory computer readable storage medium of claim 15, wherein:
receiving the first data comprises one or more of:
receiving real-time data related to current conditions of the roads;
receiving static data related to physical characteristics of the roads;
receiving historical data related to past road conditions and past accidents on the roads;
receiving driver profile data for the user who operates the vehicle; or
receiving vehicle condition data for the vehicle;
when receiving the first data comprises receiving the real-time data, the first data comprises the real-time data;
when receiving the first data comprises receiving the static data, the first data comprises the static data;
when receiving the first data comprises receiving the historical data, the first data comprises the historical data;
when receiving the first data comprises receiving the driver profile data, the first data comprises the driver profile data; and
when receiving the first data comprises receiving the vehicle condition data, the first data comprises the vehicle condition data.

17. The non-transitory computer readable storage medium of claim 15, wherein:
selecting the identified route of the potential routes further comprises:
determining a first route of the potential routes, wherein the first route comprises a first duration of time and also comprises at least one of a first quantity of risks or a first level of risk based on a risk assessment of the risk assessments for the first route;
determining a second route of the potential routes, wherein the second route comprises a second duration of time and also comprises at least one of a second quantity of risks or a second level of risk based on a risk assessment of the risk assessments for the second route, wherein the first duration of time is shorter than the second duration of time, and wherein at least one of the first quantity of risks is lower than the second quantity of risks or the first level of risk is lower than the second level of risk; and
selecting the first route as the identified route.

18. The non-transitory computer readable storage medium of claim 15, wherein:
selecting the identified route of the potential routes further comprises:
determining a first route of the potential routes, wherein the first route comprises a first duration of time and also comprises at least one of a first quantity of risks or a first level of risk based on a risk assessment of the risk assessments for the first route; and
determining a second route of the potential routes, wherein the second route comprises a second duration of time and also comprises at least one of a second quantity of risks or a second level of risk based on a risk assessment of the risk assessments for the second route, wherein the second duration of time is longer than the first duration of time, and wherein at least one of the first quantity of risks is lower than the second quantity of risks or the first level of risk is lower than the second level of risk; and
selecting the second route as the identified route.

19. The non-transitory computer readable storage medium of claim 18, further comprising at least one of:
a) transmitting a warning to the electronic device of the user that the identified route comprises a higher quantity of risks than the first route of the potential routes or comprises a higher level of risk than the first route of the potential routes; or
b) the first duration of time is longer than a predetermined maximum duration of time; and
the second duration of time is shorter than the predetermined maximum duration of time.

20. The non-transitory computer readable storage medium of claim 15, wherein:
generating the risk assessments for the potential routes based on the first data further comprises:
customizing the risk assessments for the potential routes based on the user and the vehicle such that a risk assessment based on a different user or a different vehicle is a different risk assessment than when based on the user and the vehicle; and
selecting the identified route of the potential routes further comprises:
customizing the identified route for the user and the vehicle such that an identified route for the different user or the different vehicle is a different route than for the user and the vehicle.
